(19) United States
(12) Patent Application Publication
(10) Pub. No.: US 2021/0312853 A1
(43) Pub. Date: Oct. 7, 2021

(54) AMBIENT LIGHT SENSING SYSTEM

(71) Applicant: ams AG, Premstaetten (AT)

(72) Inventors: David Harlow Sin, Eindhoven (NL); Doug Nelson, Eindhoven (NL); George Richard Kelly, Eindhoven (NL); James Archibald, Eindhoven (NL); Pradeep Hegde, Eindhoven (NL); Timothy Cogan, Eindhoven (NL)

(21) Appl. No.: 17/265,129

(22) PCT Filed: Jul. 30, 2019
(86) PCT No.: PCT/EP2019/070505

§ 371 Date: Feb. 1, 2021

Related U.S. Application Data
(60) Provisional application No. 62/713,835, filed on Aug. 2, 2018.

(51) Int. Cl. G09G 3/20; G09G 3/3233

(52) U.S. Cl. CPC G09G 3/2018; G09G 3/3233; G09G 2300/0842; G09G 2360/145; G09G 2320/0626; G09G 2360/144

(57) ABSTRACT

The disclosure describes techniques that can be useful for situations in which an ambient light sensor is disposed behind a display screen of a host device such that ambient light detected by the sensor passes through the light emitting display before being detected by the sensor.

### CROSS-REFERENCE TO RELATED APPLICATION(S)

This application claims the benefit of priority of U.S. Provisional Patent Application No. 62/713,835 filed on Aug. 2, 2018. The contents of the prior application are incorporated herein by reference.

### FIELD OF THE DISCLOSURE

This disclosure relates to ambient light sensing systems.

### BACKGROUND

A recent trend in smartphone industrial design is to maximize the screen area by reducing the bezel width and decluttering the remaining bezel area by removing apertures for optical sensors and other holes for microphones, speakers and/or fingerprint reading devices. On the other hand, there also is a trend to increase the number of optical sensors for added functionality. For example, ambient light sensors (ALSs) can be provided to facilitate adjustment of the display screen brightness to the surrounding lighting environment so as to make the display appear sharp and readable while also reducing the display's overall energy consumption.

A further trend in the smartphone market is the adoption of organic light emitting displays (OLEDs). This trend creates an opportunity to move the ALS from the smartphone's bezel to a position under the OLED. OLEDs are generally opaque primarily as a result of a protective film on their backside. This film can be removed in a very small area to allow ambient light to pass through the remaining layers of the OLED to reach the ALS. However, even with the film removed, the OLED is not very optically transmissive, thus requiring a very sensitive sensor to make ambient light detection possible. There is a further complication which makes ambient light detection through an OLED technically challenging. An ALS sensor will detect not only ambient light (e.g., background light, sunlight, etc.) passing through the display, but will also detect the light generated by the display itself. As a result, the display brightness, as driven by the ALS, will fluctuate with changes in the brightness of the pixels directly above the sensor. Such fluctuations are undesirable.

### SUMMARY

This disclosure describes portable computing devices and other apparatus that include an ambient light sensor system. The techniques described in this disclosure can be particularly advantageous for situations in which the ambient light sensor is disposed behind a display screen of a host device such that ambient light detected by the sensor passes through the light emitting display before being detected by the sensor.

For example, in one aspect, the disclosure describes an apparatus including a display screen, and an ambient light sensor disposed behind the display screen. An electronic control unit is operable to control a brightness of the display screen based on a duty cycle of a blanking PWM signal, wherein at least one OFF time of the blanking PWM signal occurs fully within a first integration period of the ambient light sensor, and wherein at least one other integration period ON time of the blanking PWM signal occurs fully during an ON time of the blanking PWM signal. The electronic control unit is further operable to acquire samples of an output of the ambient light sensor, to identify a highest value and a lowest value from among a group of the samples, and to estimate a magnitude of an ambient light signal based at least in part on the highest value and the lowest value.

The disclosure also describes a method that includes acquiring samples of an output of an ambient light sensor disposed behind a display screen having a brightness controllable by a duty cycle of a blanking PWM signal, wherein at least one OFF time of the blanking PWM signal occurs fully within a first integration period of the ambient light sensor, and wherein at least one other integration period occurs fully during an ON time of the blanking PWM signal. The method includes identifying a highest value and a lowest value from among a group of the samples, and estimating a magnitude of an ambient light signal based at least in part on the highest value and the lowest value.

Some implementations include one or more of the following features. For example, in some instances, the electronic control unit is operable to estimate the magnitude of the ambient light signal based also on a duration of an integration period of the ambient light sensor and/or based on the OFF time of the blanking PWM signal. In some implementations, the integration period of the ambient light sensor is greater than the OFF time of the blanking PWM signal. For example, in some cases, the integration period of the ambient light sensor is at least twice as large as the OFF time of the blanking PWM signal.

In another aspect, the disclosure describes an apparatus including a display screen and an ambient light sensor disposed behind the display screen. An electronic control unit is operable to control a brightness of the display screen based on a duty cycle of a blanking PWM signal. The electronic control unit is further operable to acquire samples of an output of the ambient light sensor, to identify a highest value from among a group of the samples, to determine an average value of the group of samples, and to estimate a magnitude of an ambient light signal based at least in part on the highest value and the average value.

The disclosure also describes a method that includes acquiring samples of an output of an ambient light sensor disposed behind a display screen having a brightness controllable by a duty cycle of a blanking PWM signal, identifying a highest value from among a group of the samples, determining an average value of the group of samples, and estimating a magnitude of an ambient light signal based at least in part on the highest value and the average value.

Some implementations include on or more of the following features. For example, in some instances, an ON time of the blanking PWM signal is at least twice as large as an integration period of the ambient light sensor. In some cases, the electronic control unit is operable to estimate the magnitude of the ambient light signal based also on a duration of the integration period of the ambient light sensor and/or based on an average value of all the samples occurring within a period of the blanking PWM signal.

The present techniques can be advantageous, for example, in asynchronous systems, in which the integration time of the ambient light sensor need not be synchronized with the frame rate of the display screen. In some cases, the sampling frequency can be slightly different from the display screen frame rate, which allows the sensor's integration time to come in and out of phase with the display PWM blanking time over a relatively short period. This feature, in turn, can allow the sampling time to be increased almost to the full display screen OFF time.

Other aspects, features and advantages will be readily apparent from the following detailed description, the accompanying drawings and the claims.

### BRIEF DESCRIPTION OF THE DRAWINGS

FIG. 1 illustrates various features of a host device that includes an ambient light sensor behind a display screen.

FIG. 2 shows an example of a drive circuit for an organic light emitting display.

FIG. 3 illustrates an example of sampling a blanking PWM signal according to a first implementation.

FIG. 4 is a flow chart of a method according to the first implementation.

FIG. 5 illustrates an example of sampling a blanking PWM signal according to a second implementation.

FIG. 6 is a flow chart of a method according to the second implementation.

### DETAILED DESCRIPTION

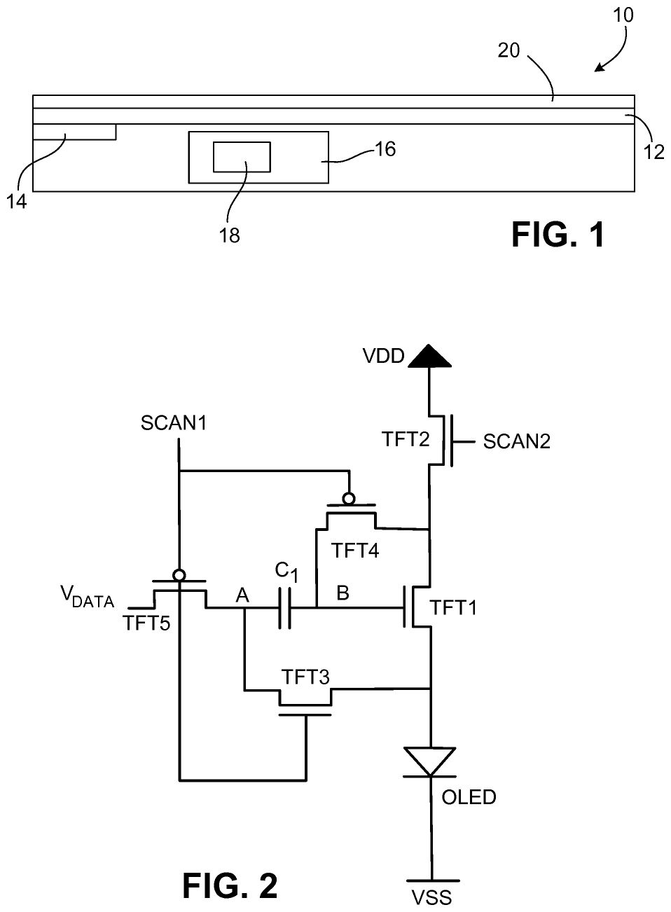

As shown in FIG. 1, a host device 10 such as a portable computing device (e.g., a smartphone, personal digital assistant (PDA), laptop or wearable) includes an OLED-type or other display screen 12, which can be disposed directly under a front glass 20. An ambient light sensor (ALS) 14 is disposed directly under a portion of the display screen 12 and is operable to sense ambient light (e.g., sunlight or other background light). The ALS 14 also may sense light generated by the display screen 12 itself. The ALS 14 can comprise one or more photodiodes or other light sensing elements, each of which is sensitive to a respective wavelength, or range of wavelengths, that may differ from one another. An electronic control unit (ECU) 16 is operable to receive, process and analyze signals from the ALS 14 and to control brightness of the display screen 12. The ECU 16 can be, for example, a processor for the sensor hub or some other processor in the portable computing device 10.

Overall brightness of the OLED can be controlled, for example, either by applying PWM modulation of each pixel with a transistor in series with the pixel or by the adjusting the overall range of current that can drive each pixel. FIG. 2 shows an example of an OLED drive circuit for a single OLED pixel. The current that drives each pixel, and therefore the brightness of each pixel, is controlled by a first transistor TFT1 depending on the charge stored on the capacitor C₁. Before each pixel is turned on, the capacitor C₁ is charged to the appropriate level, V_{DATA}, by setting the voltage SCAN1 to low. Once the voltage SCAN2 becomes high, a second transistor TFT2 turns on and allows current to flow through the OLED pixel as modulated by the first transistor TFT1. The voltage SCAN2 also is used to apply the PWM modulation to reduce the overall display brightness by applying a square waveform at a multiple of the periodic display frame rate (e.g., a multiple of 60 Hz). The duty cycle of the square wave sets the display brightness. The higher the duty cycle, the more time the blanking PWM signal is ON (i.e., a digital high signal).

In principle, the ambient light signal can be determined by estimating the light contribution from the display screen and subtracting that value from the total measured light signal (i.e., a signal representing the sum of the ambient light and the display screen light). If the duty cycle of the blanking PWM signal is relatively low (e.g., less than 40% in some instances), the duty cycle OFF time of the PWM signal may be long enough to capture the entire sample during the duty cycle OFF time. However, when the duty cycle is relatively high (e.g., 40% or higher in some instances), sampling an output from the ALS 14 during the duty cycle OFF time becomes more difficult because the blanking OFF time of the PWM signal is relatively short. Further, using a shorter integration time to capture the sensor's output samples tends to result in samples that are less reliable.

The present disclosure describes techniques and systems that utilize knowledge of the duty cycle to decouple the ambient light component from the display screen brightness. In a first implementation, as discussed in greater detail below, the ECU 16 is operable to acquire a statistically significant number of samples such that at least one sensor integration period encompasses the entirety of a duty cycle OFF time of the blanking PWM signal and such that, for at least one other integration period, the blanking PWM signal is ON (i.e., high) for the entirety of the integration period.

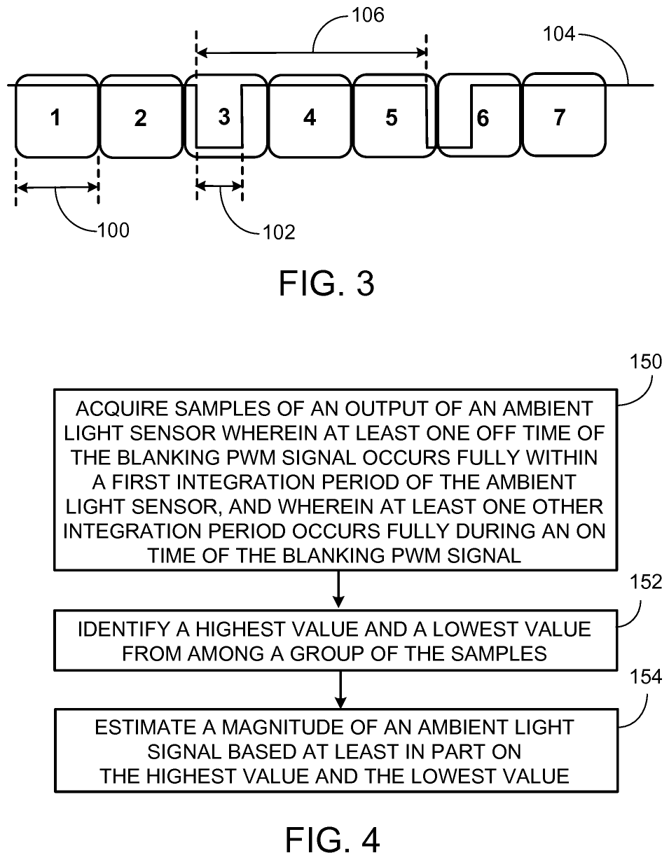

As illustrated in the example of FIG. 3, the integration time 100 for capturing signals from the ALS 14 is set to be greater than the blanking OFF time 102 of the blanking PWM signal 104. Preferably, the integration time 100 should be at least twice as large as the blanking OFF time 102 so as to help ensure that at least one sample encompasses the entirety of a duty cycle OFF time 102 of the blanking PWM signal 104 even with an arbitrary phase relationship between the integration time and the PWM signal. At the end of each integration period 100, the signal integrated by the ALS 14 is read out and acquired by the ECU 16, which then resets the ALS 14 for the next integration period. In some implementations, three or four samples are read out during each period 106 of the PWM signal, and a total of twelve to sixteen samples are acquired by the ECU 16.

In the illustrated example of FIG. 3, the blanking PWM signal 104 is ON (i.e., high) during the entirety of the first integration period 1, the second integration period 2, the fourth integration period 4 and the seventh integration period 7. On the other hand, the third integration period 3 encompasses the entirety of the duty cycle OFF time 102. During the fifth integration period 5 and the sixth integration period 6, the blanking PWM signal 104 is ON part of the time and OFF part of the time.

The ECU 16 is operable to read out the integrated signals from the ALS 14 and to store the sampled signals, for example in an array in memory (e.g., RAM) 18. The ECU 16 further is operable to identify the highest and lowest stored values, VALUE_H and VALUE_L, respectively. The high value (VALUE_H) corresponds to a sample for which the blanking PWM signal was ON for the entirety of the integration period. This value thus corresponds to integration of the ALS signal during the blanking ON period only (i.e., when the display screen was ON). Thus, the highest value represents a combination of the ambient light signal and the display screen light. In contrast, the lowest value (VALUE_L) corresponds to a sample for which the integration period encompassed the entirety of a duty cycle OFF time of the blanking PWM signal (i.e., an integration period during which the blanking PWM signal was low for at least part of the integration period). The following equations can be used for the values VALUE_L and VALUE_H:

$$VALUE\_H = Total detected light = ambient light + display screen light$$

$$VALUE\_L = [ ( \% of time the display screen is OFF ) * ( ambient light ) ] + [ ( \% of time the display screen is ON ) * ( ambient light + display screen light ) ] = [ ( blanking OFF time / integration time ) * ( ambient light ) ] + \{ [ ( integration time - blanking OFF time ] / integration time ) ] * ( ambient light + display screen light ) \}$$

These values can be used to calculate the ambient light signal independent of the display screen light, for example, as follows:

$$Ambient light = [ VALUE\_L * ( integration time / blanking OFF time ) ] - \{ VALUE\_H * [ ( integra t i on time - blanking OFF time ) / blanking OFF time ] \}$$

The integration time can be set, for example, by software that drives the ALS sensor 14. The blanking OFF time can be calculated, for example, as follows:

Blanking OFF time=(1−d)*(1/f),

where d is the duty cycle and f is the PWM frequency (e.g., 240 Hz). The ECU 16 can obtain the values for d and f, for example, from a look-up table or by using an equation based on display brightness values stored by the operating system for the host device (e.g., smart phone) in which the sensor 14 is integrated. Using these values, as well as the measured values VALUE_H and VALUE_L, the ECU 16 can determine the total ambient light signal over one integration period 100. This value can be divided by the duration of the integration period 100 to obtain the magnitude (i.e., lux) of the ambient light signal.

The ECU 16 can use the magnitude of the ambient light signal to adjust the display screen brightness so as to make the display appear sharp and readable while also reducing the display's overall energy consumption. Thus, the display screen brightness can be adjusted highly accurately in some cases based on the surrounding lighting environment.

In some instances, the ECU 16 reads out and stores N (e.g., sixteen) consecutive samples in the array in memory 18, and then identifies the high and low values (VALUE_H and VALUE_L) after storing the N samples. The ECU 16 then repeatedly performs this process and adjusts the display screen brightness as appropriate based on the calculated magnitude of the ambient light. In other instances, the ECU 16 uses a sliding array in which the oldest sample is removed from the array, and the most recent sample is added to the array. In this mode of operation, the ECU 16 can determine the high and low values (VALUE_H and VALUE_L) as each new sample is measured and stored. The brightness of the display screen 12 then can be updated, as appropriate, more frequently.

Thus, as indicated by FIG. 4, the present disclosure describes a method that includes acquiring samples of an output of an ambient light sensor disposed behind a display screen having a brightness controllable by a duty cycle of a blanking PWM signal, wherein at least one OFF time of the blanking PWM signal occurs fully within a first integration period of the ambient light sensor, and wherein at least one other integration period occurs fully during an ON time of the blanking PWM signal (150). The method includes identifying a highest value and a lowest value from among a group of the samples (152) and estimating a magnitude of an ambient light signal based at least in part on the highest value and the lowest value (154).

In some implementations, instead of calculating the ambient light signal using the high and low values (VALUE_H and VALUE_L) as described above, the ECU 16 calculates ambient light signal based on the high value (VALUE_H), as well as the average value (VALUE_AVE) of all the samples within a given PWM signal period. The ambient light signal (i.e., lux) then can be calculated, for example, as follows:

Ambient light=(N/P)*[VALUE_AVE−(VALUE_H*d)]/(1−d),

where P is the period of the PWM blanking signal, N is the number of samples during a blanking PWM period, and d is the duty cycle.

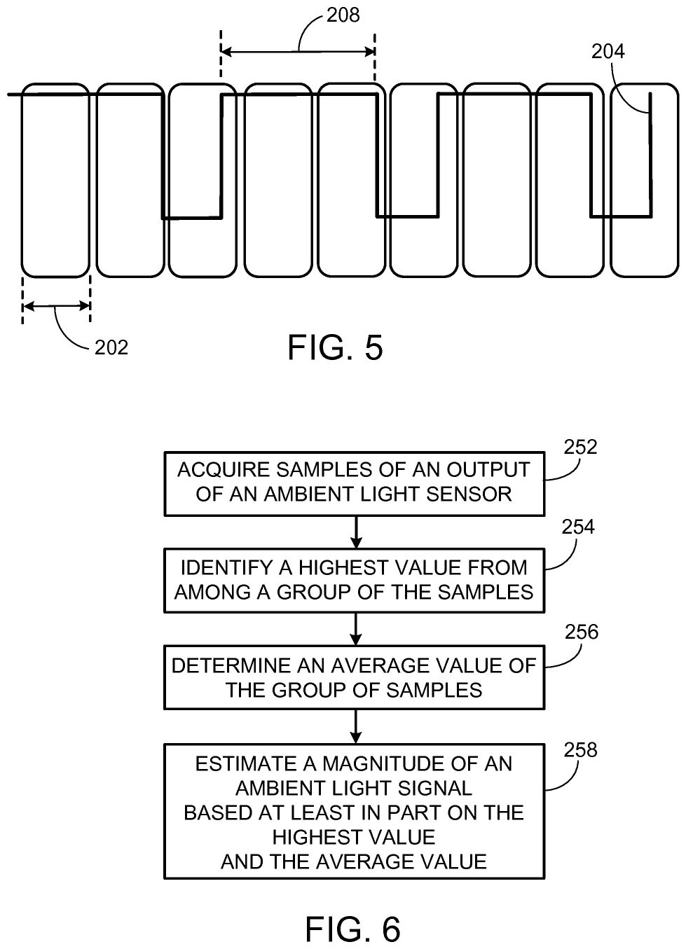

FIG. 5 illustrates an example in which the blanking PWM signal 204 has a period P. In this example, three samples are read out per blanking PWM period. Preferably, the ON time 208 of the blanking PWM signal 204 is at least twice as large as the integration time 202:

d≥(2*integration time)/P

Thus, for some implementations, assuming three samples during a blanking PWM period of 4.167 ms, the duty cycle should be greater than ⅔; likewise, assuming four samples during a blanking PWM period of 4.167 ms, the duty cycle should be greater than 50%.

Here too, the ECU 16 can use the magnitude of the ambient light signal to adjust the display screen brightness so as to make the display appear sharp and readable while also reducing the display's overall energy consumption. The display screen brightness can be adjusted highly accurately in some cases based on the surrounding lighting environment.

Thus, as shown in FIG. 6, the present disclosure describes a method that includes acquiring samples of an output of an ambient light sensor disposed behind a display screen having a brightness controllable by a duty cycle of a blanking PWM signal (252). The method also includes identifying a highest value from among a group of the samples (254), determining an average value of the group of samples (256), and estimating a magnitude of an ambient light signal based at least in part on the highest value and the average value (258).

Various aspects of the subject matter and the functional operations described in this specification can be implemented in digital electronic circuitry, or in computer software, firmware, or hardware, including the structures disclosed in this specification and their structural equivalents, or in combinations of one or more of them. Thus, aspects of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The apparatus can include, in addition to hardware, code that creates an execution environment for the computer program in question, e.g., code that constitutes processor firmware.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

A number of implementations have been described. Nevertheless, various modifications may be made without departing from the spirit and scope of the invention. Accordingly, other implementations are within the scope of the claims.

1. An apparatus comprising:
a display screen;
an ambient light sensor disposed behind the display screen; and
an electronic control unit operable to control a brightness of the display screen based on a duty cycle of a blanking PWM signal, wherein at least one OFF time of the blanking PWM signal occurs fully within a first integration period of the ambient light sensor, and wherein at least one other integration period ON time of the blanking PWM signal occurs fully during an ON time of the blanking PWM signal,
wherein the electronic control unit is further operable to acquire samples of an output of the ambient light sensor, to identify a highest value and a lowest value from among a group of the samples, and to estimate a magnitude of an ambient light signal based at least in part on the highest value and the lowest value.

2. The apparatus of claim 1 wherein the electronic control unit is operable to estimate the magnitude of the ambient light signal based also on a duration of an integration period of the ambient light sensor.

3. The apparatus of claim 2 wherein the electronic control unit is operable to estimate the magnitude of the ambient light signal based also on the OFF time of the blanking PWM signal.

4. The apparatus of claim 2 wherein the integration period of the ambient light sensor is greater than the OFF time of the blanking PWM signal.

5. The apparatus of claim 4 wherein the integration period of the ambient light sensor is at least twice as large as the OFF time of the blanking PWM signal.

6. A method comprising:
acquiring samples of an output of an ambient light sensor disposed behind a display screen having a brightness controllable by a duty cycle of a blanking PWM signal, wherein at least one OFF time of the blanking PWM signal occurs fully within a first integration period of the ambient light sensor, and wherein at least one other integration period occurs fully during an ON time of the blanking PWM signal;
identifying a highest value and a lowest value from among a group of the samples; and
estimating a magnitude of an ambient light signal based at least in part on the highest value and the lowest value.

7. The method of claim 6 including adjusting the duty cycle of the blanking PWM signal based at least in part on the estimated magnitude of the ambient light signal.

8. The method of claim 6 including estimating the magnitude of the ambient light signal based also on a duration of an integration period of the ambient light sensor.

9. The method of claim 8 including estimating the magnitude of the ambient light signal based also on the OFF time of the blanking PWM signal.

10. The method of claim 8 wherein the integration period of the ambient light sensor is greater than the OFF time of the blanking PWM signal.

11. The method of claim 10 wherein the integration period of the ambient light sensor is at least twice as large as the OFF time of the blanking PWM signal.

12. An apparatus comprising:
a display screen;
an ambient light sensor disposed behind the display screen; and
an electronic control unit operable to control a brightness of the display screen based on a duty cycle of a blanking PWM signal,
wherein the electronic control unit is further operable to acquire samples of an output of the ambient light sensor, to identify a highest value from among a group of the samples, to determine an average value of the group of samples, and to estimate a magnitude of an ambient light signal based at least in part on the highest value and the average value.

13. The apparatus of claim 12 wherein an ON time of the blanking PWM signal is at least twice as large as an integration period of the ambient light sensor.

14. The apparatus of claim 13 wherein the electronic control unit is operable to estimate the magnitude of the ambient light signal based also on a duration of the integration period of the ambient light sensor.

15. The apparatus of claim 12 wherein the electronic control unit is operable to estimate the magnitude of the ambient light signal based at least in part on the highest value and based on an average value of all the samples occurring within a period of the blanking PWM signal.

16. A method comprising:
acquiring samples of an output of an ambient light sensor disposed behind a display screen having a brightness controllable by a duty cycle of a blanking PWM signal;
identifying a highest value from among a group of the samples;
determining an average value of the group of samples; and
estimating a magnitude of an ambient light signal based at least in part on the highest value and the average value.

17. The method of claim 16 wherein an ON time of the blanking PWM signal is at least twice as large as an integration period of the ambient light sensor.

18. The method of claim 17 including estimating the magnitude of the ambient light signal based also on a duration of the integration period of the ambient light sensor.

19. The method of claim 16 including estimating the magnitude of the ambient light signal based at least in part on the highest value and based on an average value of all the samples occurring within a period of the blanking PWM signal.
